(19) United States
(12) Patent Application Publication
(10) Pub. No.: US 2014/0327557 A1
(43) Pub. Date: Nov. 6, 2014

(54) DISPLAY METHOD AND DISPLAY SYSTEM FOR A VEHICLE

(71) Applicants: Stefan Nordbruch, Kornwestheim (DE); Martin Rous, Mundelsheim (DE)

(72) Inventors: Stefan Nordbruch, Kornwestheim (DE); Martin Rous, Mundelsheim (DE)

(21) Appl. No.: 14/349,294

(22) PCT Filed: Aug. 6, 2012
(86) PCT No.: PCT/EP2012/065351

§ 371 Date: Jul. 24, 2014

(30) Foreign Application Priority Data
Oct. 6, 2011 (DE) 10 2011 084 084.2

(51) Int. Cl. B60Q 9/00

(52) U.S. Cl. CPC B60Q 9/008
USPC 340/902

(57) ABSTRACT

A display method for a vehicle includes the following steps: determining a vehicle position, retrieving vehicle surroundings data from a database corresponding to the determined vehicle position, detecting the vehicle surroundings, and displaying a vehicle surroundings view based on the retrieved vehicle surroundings data and the detected vehicle surroundings.

### BACKGROUND OF THE INVENTION

1. Field of the Invention

The present invention relates to a display method and a display system for a vehicle, as well as to a driver assistance system for a vehicle as well as a computer program.

2. Description of the Related Art

Driver assistance systems and driver information systems are known as such from published U.S. patent application document US 2009/0092334 A1, for example. In this patent application, a system is described which is also referred to as a “surround view” and/or a “bird view” system. Here, an area around a vehicle is recorded with the aid of a camera. The recorded area is then displayed to a driver on a monitor.

Here, it may occur, for example, that the camera fails or is not able to completely record some sections in the area. This may result in the view on the monitor being incomplete or even faulty.

### BRIEF SUMMARY OF THE INVENTION

The object underlying the present invention may therefore be seen as providing an improved display method for a vehicle which enables a reliable representation of vehicle surroundings, even if corresponding surroundings sensors fail.

The object underlying the present invention may also be seen as providing a corresponding display system for a vehicle.

The object underlying the present invention may furthermore be seen as providing a corresponding driver assistance system for a vehicle as well as a computer program.

According to one aspect, a display method for a vehicle is provided. A vehicle position is determined. Subsequently, vehicle surroundings data are retrieved from a database, the vehicle surroundings data corresponding to the determined vehicle position. This therefore means in particular that vehicle surroundings data which area associated with the determined vehicle position are retrieved from the database.

Moreover, vehicle surroundings are detected. A vehicle surroundings view is then displayed, the vehicle surroundings view being based on the retrieved vehicle surroundings data and the detected vehicle surroundings.

According to another aspect, a display system for a vehicle is provided. The display system includes a position determination device with the aid of which a vehicle position may be determined. Furthermore, a retriever is provided which is able to retrieve vehicle surroundings data corresponding to the determined vehicle position from a database. This therefore means in particular that the retriever poses a request to the database, so that the database then transmits the corresponding vehicle surroundings data to the retriever.

Furthermore, the display system includes a detection device for detecting the vehicle surroundings. Moreover, a display device is provided for displaying a vehicle surroundings view which is based on the retrieved vehicle surroundings data and the detected vehicle surroundings.

According to yet another aspect, a driver assistance system for a vehicle is provided, the driver assistance system including a display system for a vehicle.

According to yet another aspect, a computer program is provided, the computer program including program code for carrying out the display method for a vehicle when the computer program is executed on a computer.

The present invention thus includes the idea, in particular, that a vehicle surroundings view which may be provided for the view of a driver in particular may be formed not only based on the detected vehicle surroundings, but also based on the vehicle surroundings data stored in a database. This therefore means in particular that even if the vehicle surroundings are detected incorrectly or the detection device malfunctions or fails completely, a vehicle surroundings view may still be formed based on the retrieved vehicle surroundings data. Thus, a vehicle surroundings view of his/her vehicle is reliably provided to a driver. A driving safety is therefore advantageously increased.

Vehicle surroundings data in the sense of the present invention include, in particular, information regarding the vehicle surroundings. Such information may, for example, relate to physical objects. A physical object may, for example, be a traffic sign, a signaling system, or a road boundary post. The vehicle surroundings data, in particular, include physical properties or characteristics of the road, such as a road width, a lane width, radiuses of curves, and/or ramps. In particular, in the case of stationary physical objects, the particular positions and dimensions are stored in the vehicle surroundings data. Vehicle surroundings data may, in particular, also include information regarding instantaneous conditions such as road works in the corresponding position, resulting in changed road properties. Vehicle surroundings data may, in particular, also include roadway lane data which, for example, include the information regarding a roadway line color.

Vehicle surroundings data in the sense of the present invention include in particular images and/or videos, so that in the case of a corresponding request with the aid of the retriever, the relevant videos and/or images are transmitted to the display system, so that the displayed vehicle surroundings view may advantageously include the corresponding videos or images.

A corresponding position is in particular assigned to the vehicle surroundings data, so that the corresponding vehicle surroundings data at the vehicle position may be made available to the display system for further processing based on the determined vehicle position.

According to another specific embodiment, another vehicle may be provided. Preferably, other vehicle surroundings data corresponding to other vehicle surroundings of the other vehicle are received, the vehicle surroundings view being additionally displayed based on the other vehicle surroundings data. This therefore means in particular that the display device is configured to additionally display the vehicle surroundings view based on other vehicle surroundings data corresponding to the other vehicle surroundings of the other vehicle. This therefore means in particular that the other vehicle detects its corresponding vehicle surroundings and transmits the resulting other vehicle surroundings data to the vehicle, so that it then computes its own vehicle surroundings view based on the other vehicle surroundings data. For example, the other vehicle may travel on the right next to the vehicle, so that the vehicle is not able to detect the vehicle surroundings on its right, since the other vehicle is in the way of the detection device. However, the other vehicle surroundings data may then be advantageously used to display the area on the right next to the vehicle in a vehicle surroundings view. In particular when the other vehicle is traveling ahead of the vehicle, the corresponding other vehicle surroundings data may be advantageously used for the vehicle in order to display to the driver of the vehicle what is located far ahead in relation to his/her vehicle. Potential obstacles or hazards may thus be detected in due time.

The other vehicle surroundings data preferably include real-time video data. In particular, the other vehicle surroundings data may also include real-time image data. This therefore means in particular that the driver of the vehicle may be made available a live view with regard to the other vehicle surroundings of the other vehicle. This therefore means in particular that the driver is also able to see what the driver of the other vehicle is able to see.

According to another specific embodiment, a transmitter is provided which may transmit display data to the other vehicle and/or to the database, the display data corresponding to the displayed vehicle surroundings view. In this way, the other driver of the other vehicle may in particular advantageously learn a piece of information regarding what the driver of the vehicle sees. The database may, for example, advantageously check its own vehicle surroundings data based on the transmitted display data and update and/or make these data available to an operator for manual correction, if necessary. It may preferably also be provided that the database makes available the transmitted vehicle surroundings view data to even multiple other vehicles, in particular the other vehicle.

According to another specific embodiment, the detection device is designed to detect a geometric variable of a physical object of the vehicle surroundings. This therefore means in particular that a geometric variable of a physical object of the vehicle surroundings is detected, and the vehicle surroundings view is displayed together with the physical object and the geometric variable. This therefore means in particular that a piece of information regarding the size, the length, or the height of the physical object is advantageously displayed to the driver. The following text may, for example, appear next to a displayed roadway: “Lane width is 3 m.” The following text may, for example, also appear next to a physical object: “Object is in position x, y, z and has the dimensions h, w, d.” Here, letters x, y, z and h, w, d, represent corresponding numerical values, h representing height, w representing width, and d representing depth. It may preferably be provided that the detected physical object is classified. This therefore means in particular that the detected object is assigned the information regarding what the object is. For example, the object may be classified as a pedestrian, a road boundary post, a roadway marking, a traffic sign, a signaling system, a building, a vehicle, or as a tree.

According to another specific embodiment, the database is integrated into the display system. Here, such a database may also be referred to as an internal database. For updating purposes, such an internal database may, for example, communicate with another external database via a wireless communication process, in particular WLAN and/or a mobile radio communication process, preferably a long-term evolution (LTE) communication process. It may also be provided that an update of the internal database may be carried out with the aid of a data carrier including corresponding updated vehicle surroundings data.

According to another specific embodiment, it may be provided that the database is situated externally from the display system. This therefore means in particular that the database is situated outside of the vehicle. A communication between the display system and the database may then be carried out in particular with the aid of the previously mentioned wireless communication processes. Such a database may also be referred to as an external database. For a communication between the external database and the display system, it may be provided that the corresponding communication interface is fixedly situated in the vehicle, e.g., in a central control unit. For example, the transmission may also be carried out with the aid of an external device such as a cellular phone, in particular a smart phone. This device may then, for example, in turn communicate with the vehicle or the display system, in particular with the aid of a Bluetooth communication process.

According to another specific embodiment, it may be provided that a communication is carried out between the vehicle and the external database with the aid of a C2I process, for example. The abbreviation C2I stands in this case for “car to infrastructure.” A C2I communication process therefore refers to a communication process between a vehicle and an infrastructure or a physical object which is not a vehicle, e.g., a signaling system or a base station.

According to one specific embodiment, it may be provided that surroundings data are transmitted to the vehicle from a stationary infrastructure or a stationary physical object, which is not a vehicle, the surroundings data corresponding to the surroundings of the infrastructure. Such an infrastructure may be, for example, a signaling system, a bridge, or a building. The communication between the infrastructure and the vehicle may, in particular, be carried out with the aid of the C2I process. It may preferably be provided that a sensor system, as will be described in the following, is situated at such an infrastructure, the sensor system sensorially detecting the surroundings of the infrastructure. The corresponding surroundings data are then transmitted to the vehicle, so that the surroundings of the infrastructure may be advantageously displayed to the driver. This therefore means that the display device may display a surroundings view corresponding to the surroundings data additionally or alternatively to the vehicle surroundings view. The driver thus advantageously knows what the surroundings of the infrastructure look like, even if the vehicle is not even in the visual range yet, for example, and is able to plan his/her driving maneuvers in an accordingly anticipatory manner, thus significantly advantageously increasing a vehicle's safety. Even in situations in which the sensor system of the vehicle does not make available any corresponding data, since, for example, a sensor of the sensor system is covered, and/or in which another sensor system of another vehicle does not make available any corresponding data, since, for example, a sensor of the other sensor system is covered, the driver knows what his/her surroundings look like, since the corresponding data are made available with the aid of the sensor system of the infrastructure.

According to another specific embodiment, the computation for the corresponding vehicle surroundings view is carried out internally in the display system. This therefore means in particular that the display system has a corresponding processing device which processes the data for display. It may preferably also be provided that a corresponding computation is carried out externally from the display system. In particular, the external database may, for example, carry out a corresponding computation of a vehicle surroundings view and transmit these data corresponding to the computed vehicle surroundings view to the display system for display. In particular, this specific embodiment has the advantage that the display system itself does not need a computing device or only needs a computing device of small capacity. The computation may preferably be carried out internally in the vehicle or in the display system or also externally in the external database.

According to another specific embodiment, it may be provided that the vehicle trajectory data are received correspondingly to a vehicle trajectory of the other vehicle, the vehicle trajectory of the other vehicle being displayed together with the vehicle surroundings view. In this way, the driver of the vehicle advantageously learns about a corresponding trajectory of the other vehicle and is thus able to advantageously accordingly adapt his/her own driving maneuvers. In particular, it may also be provided that a vehicle trajectory of the host vehicle is displayed. In particular, a planned route profile of a navigation system may be used for the computation of the vehicle trajectory, be it for the host vehicle and/or the other vehicle, thus providing the possibility of also advantageously displaying a future vehicle trajectory. It may be preferably provided that in the case of a possible collision of the vehicle with the other vehicle, a corresponding collision warning is displayed to the driver of the vehicle and/or the other driver of the other vehicle. Preferably, data from one or multiple driver assistance systems of the other vehicle are transmitted from the other vehicle to the vehicle. These data may then be in particular advantageously used for a computation of a possible collision. This computation may be carried out in particular already in the other vehicle, so that the result of the computation is preferably transmitted to the vehicle and displayed there. In general, the data of the driver assistance systems of the other vehicle may be used to operate one or multiple driver assistance systems of the vehicle. This therefore means in particular that the driver assistance systems of the vehicle may use data from the driver assistance systems of the other vehicle to make available corresponding driver assistance functions.

Driver assistance system data from driver assistance systems of the vehicle may preferably also be used additionally or alternatively to the data of the driver assistance systems of the other vehicle to compute and display a corresponding surroundings view of the vehicle.

It may in particular be provided that the computations which are based on all available data and which are necessary for computing and displaying a vehicle surroundings view are carried out in a corresponding computing device in the vehicle. It may preferably be provided that the computations are carried out externally from the vehicle in an external server. In particular, a combination of an internal computation, i.e., in the vehicle, and an external computation, i.e., in the external server, may be provided.

According to another specific embodiment, it may be provided that more recent vehicle surroundings data are preferred over less recent vehicle surroundings data for displaying a corresponding vehicle surroundings view. This advantageously results in the vehicle surroundings view displayed to the driver being instantaneous and not outdated.

According to yet another specific embodiment, the driver assistance system may be a lane recognition system, a lane keeping assistance system, a cruise control, an adaptive cruise control, or a lane change assistance system. This therefore means in particular that the corresponding data, such as the display data, may be generally made available to the driver assistance system, so that it may then be operated as a function of the data.

According to another specific embodiment, the detection device may have a sensor system for sensory detection of the vehicle surroundings. Such a sensor system may in particular include a video sensor. For example, the sensor system may also include radar sensors and/or ultrasonic sensors and/or lidar sensors.

The detection device preferably includes one or multiple video cameras. Such a sensor system mentioned above, in particular the video cameras, may in particular also be situated at an infrastructure, as described above. The data provided with the aid of the individual sensors may be advantageously used to compute and display a corresponding virtual vehicle surroundings view. Thus, a vehicle surroundings view is advantageously available, even if real data of a video sensor are not available. It may in particular be provided that data of a navigation system are used for a virtual vehicle surroundings view. For example, such data of a navigation system may be map data of a digital map.

According to one specific embodiment, it may also be provided in the case of missing vehicle surroundings data that the corresponding vehicle surroundings view identifies the corresponding areas with regard to the missing vehicle surroundings data as those areas for which there are no vehicle surroundings data available. For example, such areas may be identified using black or white spots. This results in the driver advantageously learning about the areas which do not have a corresponding data basis, so he/she may pay closer attention in these areas. It may in particular be provided that one or multiple areas display partial views, in particular virtual partial views, of the vehicle surroundings which are based on data from sensors of the vehicle, on data from sensors of the other vehicle, or on data of a sensor system of an infrastructure. In this way, a driver is aware of his/her vehicle surroundings view, even if his/her own video camera does not provide sufficient data.

In another specific embodiment, multiple other vehicles may also be provided. The specific embodiments described in the context of the other vehicle also analogously apply to multiple other vehicles.

The present invention is described in greater detail in the following on the basis of the preferred exemplary embodiments with reference to the drawings.

### BRIEF DESCRIPTION OF THE DRAWINGS

FIG. 1 shows a flow chart of a display method for a vehicle.

FIG. 2 shows a display system for a vehicle.

FIG. 3 shows another display system for a vehicle.

FIG. 4 shows a driver assistance system for a vehicle.

FIG. 5 shows a vehicle.

FIG. 6 shows a vehicle surroundings view.

### DETAILED DESCRIPTION OF THE INVENTION

The same reference numerals are used below for the same features.

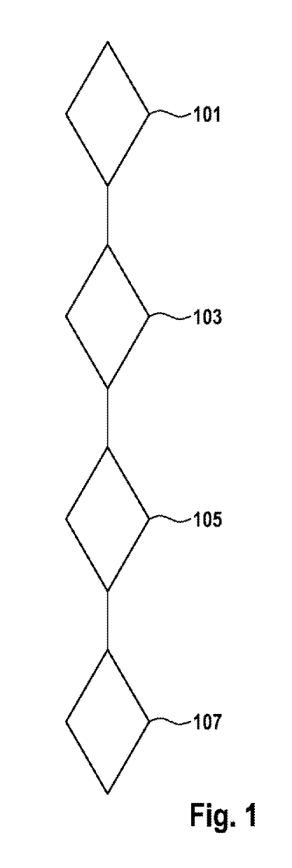

FIG. 1 shows a flow chart of a display method for a vehicle. In a step 101, a vehicle position is determined. According to a step 103, vehicle surroundings data are then retrieved from a database corresponding to the determined vehicle position. This therefore means in particular that a corresponding request is posed or transmitted to the database, whereupon it transmits or makes available the corresponding vehicle surroundings data.

According to a step 105, the vehicle surroundings are furthermore detected. In particular, detecting the vehicle surroundings includes recording video images or video data streams of the vehicle surroundings. In a step 107, a vehicle surroundings view is then displayed which is based on the retrieved vehicle surroundings data and the detected vehicle surroundings. This therefore means in particular that the displayed vehicle surroundings view includes both a view corresponding to the detected vehicle surroundings and a vehicle surroundings view corresponding to the vehicle surroundings data.

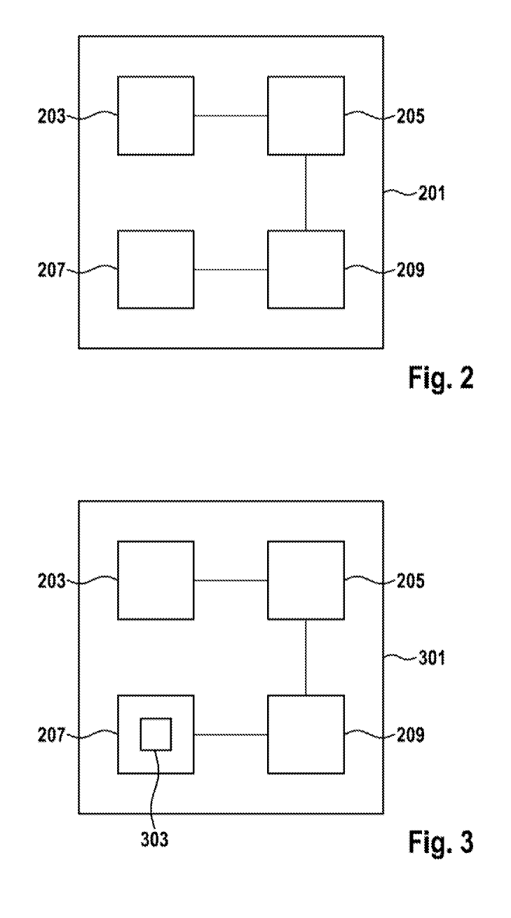

FIG. 2 shows a display system 201 for a vehicle (not shown). Display system 201 includes a position determination device 203 for determining a vehicle position. Furthermore, a retriever 205 is provided which is able to retrieve vehicle surroundings data from a database corresponding to the determined vehicle position. This therefore means in particular that retriever 205 poses a corresponding request to the database, whereupon the database transmits the corresponding vehicle surroundings data to retriever 205.

Display system 201 furthermore includes a detection device 207 for detecting the vehicle surroundings. The detection device in particular includes one or multiple video cameras. Furthermore, a display device 209 is provided which may display a vehicle surroundings view which is based on the retrieved vehicle surroundings data and the detected vehicle surroundings.

Due to the fact that in addition to a view corresponding to the detected vehicle surroundings, a view corresponding to the vehicle surroundings data from the database is displayed, it is possible to provide the driver with a precise and reliable vehicle surroundings view, even if the detection device is not able to completely detect the vehicle surroundings or if the detection device malfunctions. This means, for example, that the video camera of the detection device may fail, for example, but the driver may still be provided with a vehicle surroundings view.

FIG. 3 shows another display system 301 which is essentially designed similarly to display system 201 in FIG. 2.

Detection device 207 of display system 301 according to FIG. 3 also includes a video camera 303 which may record a video of the vehicle surroundings. Multiple video cameras may preferably also be provided.

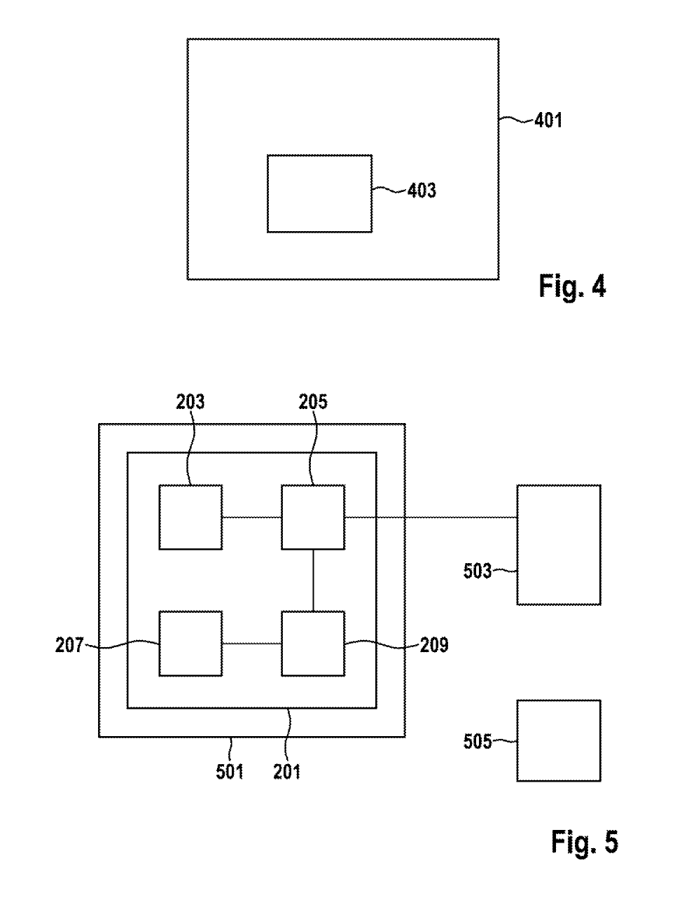

FIG. 4 shows a driver assistance system 401 for a vehicle including a display system 403. Display system 403 may, for example, be display system 201 or 301 according to FIG. 2 or FIG. 3, respectively. This therefore means in particular that the corresponding data, such as the display data, may be made available to driver assistance system 401, so that driver assistance system 401 may be operated or controlled as a function of these data. This therefore means in particular that the video data of a video camera may, for example, be made available to driver assistance system 401, so that it makes a decision based on these video data as to whether it carries out an intervention into a drive system, a braking system and/or a steering system.

FIG. 5 shows a vehicle 501 including a display system 201 according to FIG. 2. In another specific embodiment (not shown), it may be provided that vehicle 501 may also include display system 301 or driver assistance system 401 according to FIG. 3 or FIG. 4, respectively. Moreover, an external database 503 is provided. This therefore means in particular that external database 503 is situated outside of vehicle 501. Retriever 205 poses a corresponding request to external database 503, in which the vehicle surroundings data are stored, with regard to the vehicle surroundings data at the vehicle position determined with the aid of position determination device 203. The requested vehicle surroundings data are then transmitted from external database 503 to retriever 205.

Moreover, another vehicle 505 is also provided which may in particular detect its corresponding vehicle surroundings, the corresponding other vehicle surroundings data then being transmitted also to display system 201, so that the other vehicle surroundings of other vehicle 505 may also be displayed with the aid of display device 209. It may be preferably provided that the display data corresponding to the displayed vehicle surroundings view may be made available to external database 503 and/or other vehicle 505. Other vehicles may preferably also be provided, a corresponding communication between the individual vehicles taking place in a similar manner.

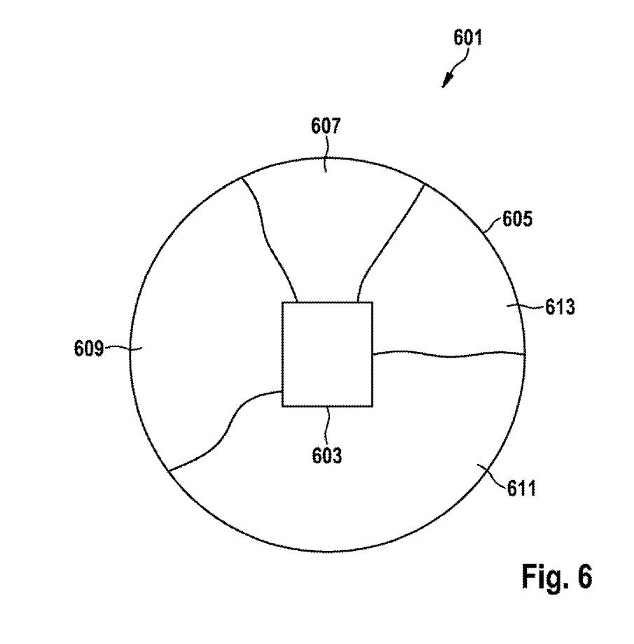

FIG. 6 shows a vehicle surroundings view 601 as it may be displayed, for example, with the aid of display device 209. A vehicle 603 is schematically centrally illustrated. A vehicle surroundings area around vehicle 603 is identified in this case with the aid of a circle having reference numeral 605. Vehicle surroundings area 605 may preferably also be identified with the aid of different geometric shapes, e.g., with the aid of a square or a triangle.

Vehicle surroundings area 605 has multiple subareas 607, 609, 611, and 613. Subarea 607 shows, for example, a corresponding partial view of the vehicle surroundings which is based on the sensors of a video camera of vehicle 603. Subarea 609 shows, for example, a corresponding partial view of the vehicle surroundings which is based on the sensors of a video camera of another vehicle which is not shown here. Subarea 611 shows, for example, a corresponding partial view of the vehicle surroundings which is based on the sensors of a video camera of an infrastructure. Subarea 613 shows, for example, a corresponding virtual partial view of the vehicle surroundings which is based on the data of a digital map of a navigation system.

Thus, a vehicle surroundings view may be preferably composed of multiple partial views, each of which is based on data from different sensors, in particular radar sensors and/or ultrasonic sensors and/or lidar sensors, or from systems such as a navigation system and/or a driver assistance system. Preferably, one or multiple subarea(s) may also be provided for which there is no data available for a corresponding partial view. Such subareas are then in particular identified as such, in particular with the aid of white, black, or differently colored spots.

1-16. (canceled)

17. A method for displaying a view on a display device in a host vehicle, comprising:
determining a vehicle position of the host vehicle;
retrieving, from a database, vehicle surroundings data corresponding to the determined vehicle position;
detecting vehicle surroundings of the host vehicle; and
displaying a vehicle surroundings view of the host vehicle based on the retrieved vehicle surroundings data and the detected vehicle surroundings.

18. The display method as recited in claim 17, wherein additional vehicle surroundings data corresponding to vehicle surroundings of a second vehicle are received by the host vehicle, and wherein the vehicle surroundings view of the host vehicle is displayed additionally based on the additional vehicle surroundings data.

19. The display method as recited in claim 18, wherein the additional vehicle surroundings data include real-time video data.

20. The display method as recited in claim 18, wherein display data corresponding to the displayed vehicle surroundings view of the host vehicle are made available to at least one of the second vehicle and the database.

21. The display method as recited in claim 17, wherein additional surroundings data are transmitted to the host vehicle from a stationary physical object, the additional surroundings data corresponding to the surroundings of the physical object, and wherein an additional surroundings view corresponding to the additional surroundings data is displayed one of additionally or alternatively to the vehicle surroundings view.

22. The display method as recited in claim 18, wherein vehicle trajectory data corresponding to a vehicle trajectory of the second vehicle are received by the host vehicle, and the vehicle trajectory of the second vehicle is displayed together with the vehicle surroundings view of the host vehicle.

23. The display method as recited in claim 22, wherein based on the vehicle trajectory data of the second vehicle, a probability of collision between the host vehicle and the second vehicle is computed, and a collision warning is displayed when the collision probability is greater than a predetermined probability threshold.

24. The display method as recited in claim 17, wherein a geometric variable of a physical object in the vehicle surroundings is detected, and the vehicle surroundings view of the host vehicle is displayed together with the physical object and the geometric variable.

25. The display method as recited in claim 24, wherein the physical object is classified.

26. A display system for a host vehicle, comprising:
a position determination device for determining a vehicle position of the host vehicle;
a retriever for retrieving from a database vehicle surroundings data corresponding to the determined vehicle position of the host vehicle;
a detection device for detecting vehicle surroundings of the host vehicle; and
a display device for displaying a vehicle surroundings view of the host vehicle based on the retrieved vehicle surroundings data and the detected vehicle surroundings.

27. The display system as recited in claim 26, wherein the display device is configured to display the vehicle surroundings view based on additional vehicle surroundings data corresponding to vehicle surroundings of a second vehicle.

28. The display system as recited in claim 27, wherein the additional vehicle surroundings data include real-time video data.

29. The display system as recited in claim 27, further comprising:
a transmitter for transmitting display data corresponding to the displayed vehicle surroundings view to at least one of the second vehicle and the database.

30. The display system as recited in claim 26, wherein the detection device is configured to detect a geometric variable of a physical object in the vehicle surroundings.

31. The display system as recited in claim 27, wherein the display system is part of a driver assistance system of the host vehicle.

32. A non-transitory computer-readable data storage medium storing a computer program having program codes which, when executed on a computer, performs a method for displaying a view on a display device in a host vehicle, the method comprising:
determining a vehicle position of the host vehicle;
retrieving, from a database, vehicle surroundings data corresponding to the determined vehicle position;
detecting vehicle surroundings of the host vehicle; and
displaying a vehicle surroundings view of the host vehicle based on the retrieved vehicle surroundings data and the detected vehicle surroundings.
